(19) United States
(12) Patent Application Publication
(10) Pub. No.: US 2010/0064866 A1
(43) Pub. Date: Mar. 18, 2010

(54) OPTICAL FIBER FLAIL WITH INTEGRATED POWER SUPPLY AND LIGHT SOURCE FOR ROTARY CUTTING TOOLS

(75) Inventor: Basil Norman Freeman, Sherwood Park (CA)

Correspondence Address: BROOKS KUSHMAN P.C., 1000 TOWN CENTER, TWENTY-SECOND FLOOR, SOUTHFIELD, MI, 48075, US

(73) Assignee: INNOVER TECHNOLOGIES LTD., Sherwood Park Alberta (CA)

(21) Appl. No.: 12/513,212

(22) PCT Filed: Oct. 29, 2007
(86) PCT No.: PCT/CA07/01922

§ 371 Date: May 1, 2009

Related U.S. Application Data
(60) Provisional application No. 60/863,807, filed on Nov. 1, 2006.

(51) Int. Cl. B26D 1/00; B26D 7/00

(52) U.S. Cl. 83/13; 83/520

(57) ABSTRACT

A method of improving the control of a rotary cutting machine is disclosed. The cutting element of the rotary cutting machine being a filament which is rotated at high velocity under the control of a motor, such as powered by a battery or gasoline. The invention provides within the lower rotating head of the rotary cutting machine an optical source which illuminates the filament such that the distal rotating end of the filament provides a visual indication to an operator of the location of the rotating cutting element. In an embodiment of the invention the electrical power for the optical source is provided by providing an electrical generator within the rotary cutting machine such that for example the rotor is within the rotating head and the stator within the upper body of the rotary cutting machine.

### FIELD OF THE INVENTION

The invention relates to rotary cutting tools and more particularly to providing visual indication of the cutting tool location in operation.

### BACKGROUND OF THE INVENTION

Landscapers, farmers, and individuals are offered a wide variety of tools to enable the maintenance of landscaping, gardens, agricultural environments and other environments where control of vegetation is required. Amongst these are a range of devices employing one or more flexible cord-like filament cutting surfaces which are devices that work on the principle that the line when turned fast enough it is held out from its housing, typically a rotating reel, very stiffly by centrifugal force. The faster it turns the stiffer the line, and even relatively narrow round-section nylon line is able to cut grass and slight, woody, plants quite well. Some monofilament lines, designed for more powerful cutters, have an extruded shape, such as a star, that helps the line slash the material being cut and thus it is able to cut quite large woody plants or, at least, ring-bark them very effectively. These cord-like cutting devices making disk type devices less necessary for even tough jobs.

Existing radial cutting devices using filament cutting flails are difficult to operate as the filament is difficult to see when these devices are rotating at high speed. Operators of such devices find it difficult to accurately direct these devices towards their desired cutting path making it difficult to trim vegetation at an appropriate angle of attack. Because existing flail type cutting devices are so difficult to direct they often cut in the wrong place and can destroy plants, lawn and other objects needlessly. Existing devices are unsafe to use as the operator or others standing in close proximity can be injured by solid debris which is accidentally thrown up by a misdirected tool.

The filament typically utilized in existing devices is brightly colored, ostensibly to better enable the operator to see where the path of the cutting will be. In practice it is very difficult to see the filament when these devices are in use amongst vegetation, and spinning at high speeds. The bright coloring of the filament only marginally improves the operator's ability to see the cutting path in bright sunlight and has no noticeable effect under lower lighting conditions. Because it is difficult to see the filament, operators using “bump and feed” devices, wherein bumping the bottom of the device releases a clamp on the filament allowing the filament to feed out under centrifugal force, cannot ascertain how much filament has been released. As a result often the operator will prematurely release more filament leading to needless wastage. Operators also often do not operate existing devices with the filament at its optimal length because the filament is so difficult to see. This leads to the inefficient operation of existing devices as the filament is too short and consequently spins at a lower speed than that required for optimal cutting efficiency.

It would be beneficial therefore to provide a means of increasingly the visibility of the filament to the operator when in use, thereby allowing them to easily ascertain the current position of the spinning filament, gauge it's length, and control the positioning of the filament relative to the vegetation being cut. It would also be beneficial if the increased visibility could also be maintained for cordless devices.

### SUMMARY OF THE INVENTION

In accordance with the invention there is provided a method comprising providing a rotating head comprising at least an optical source, the rotating head forming a predetermined portion of a rotary cutting device. The method further comprising providing a coupling, the coupling providing at least a demountable interface for a filament to provide an optical coupling between the optical source and the filament, and providing electrical power to operate the optical source and thereby providing an illumination visible to an operator of an exposed distal end of the filament during operation of the rotary cutting device.

In accordance with another embodiment of the invention there is provided a rotary cutting device comprising a body comprising at least a handle and a motor; and a rotating head attached to the motor and able to freely rotate with respect to the body, the rotating head comprising at least a demountable mount for a filament, and an optical source optically coupled to the filament and providing an illumination of the filament when electrically powered

In accordance with another embodiment of the invention there is provided a method of controlling a cutting action comprising providing a rotary cutting device comprising at least an upper body comprising at least a motor and a lower body comprising at least an optical source coupled to an electrical circuit, the electrical circuit connected to a source of electrical power. The method comprising providing a filament demountably attached to the lower body having a first end optically coupled to the optical assembly and a second distal end wherein operating the rotary cutting device results in electrical power being provided to the electrical circuit to operate the optical source and thereby provide a visual indication to an operator of the location of the second distal end of the filament.

In accordance with another embodiment of the invention there is provided a method of controlling a cutting action comprising providing a rotary cutting device comprising at least a means of providing electrical power to operate an optical source forming a predetermined portion of the rotary cutting device, the optical source therein illuminating a first end of a filament and providing a visual indication of the location of a second distal end of the filament to an operator of the rotary cutting device, the visual indication improving a measure of control of the rotary cutting device.

### BRIEF DESCRIPTION OF THE DRAWINGS

The invention will now be described in conjunction with the following drawings, representing one embodiment of the invention, in which:

FIG. 1 is a front perspective view of the apparatus in accordance with an embodiment of the invention, including the plastic optical fiber cutting filament. The plastic optical fiber cutting filament is shown in a stationary position.

FIG. 2 is a front perspective view of the apparatus shown in FIG. 1. The cutting head is shown whilst it is in rotation and the corresponding light trail created by light emanating from the tips of the plastic optical fiber filament is shown.

FIG. 3A is a front perspective view of the apparatus shown in FIG. 1 showing the cutting head and filament when attached to the stationary drive shaft of a trimmer, edger of vegetation or rotary cutting device.

FIG. 3B is a front perspective view of the apparatus shown in FIG. 1 showing the cutting head and light trail when attached to the rotating drive shaft of a trimmer, edger of vegetation or rotary cutting device.

FIG. 4 is a cross-sectional view taken in a vertical plane of the apparatus shown in FIG. 1 showing for a first embodiment the positioning of the plastic optical fibers, circuitry, light emitting diode, and electrical generation components.

FIG. 5 is a cross-sectional view taken in a vertical plane of the apparatus shown in FIG. 1 showing for a second embodiment the positioning of the plastic optical fibers, circuitry, light emitting diode, focusing optics, and electrical generation components.

FIG. 6 is a flow chart showing the interaction of the electrical components of the apparatus.

### DETAILED DESCRIPTION OF EMBODIMENTS OF THE INVENTION

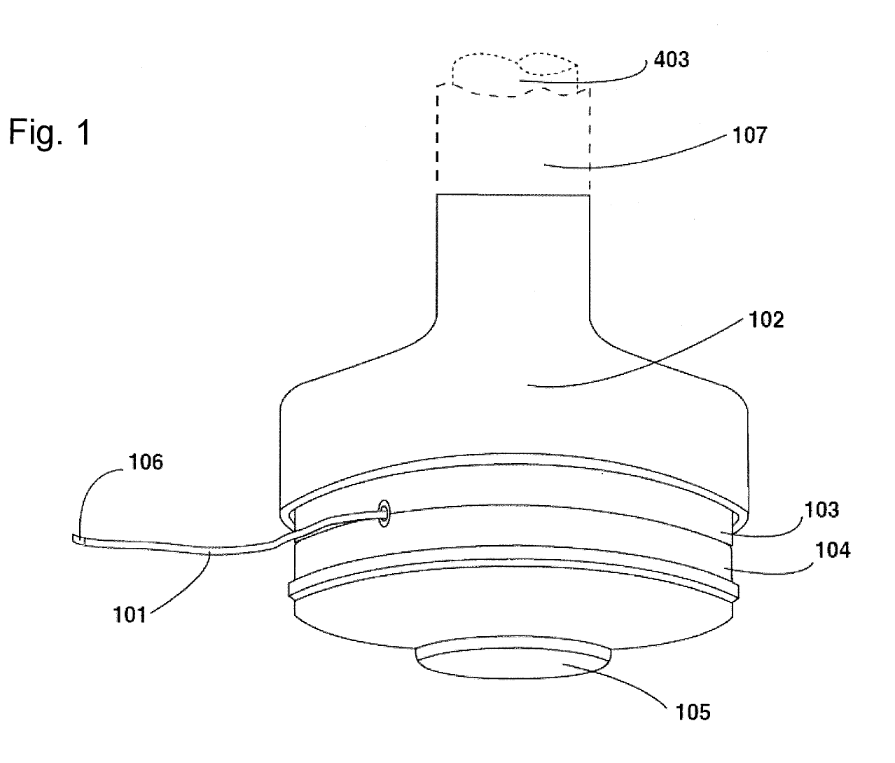

The present invention which addresses the foregoing limitations is described below in two embodiments, the first with reference to FIGS. 1 through 4, and the second with reference to FIGS. 1 through 5. In each embodiment the invention provides for an apparatus that enables the operator of such equipment to visually see the tip of the cutting flail and thus guide the cutting tool to its correct cutting path. The operator can clearly see the outermost tip of the cutting tool and can thus ensure that the target material is cut appropriately without causing undue damage to other objects. In order to achieve this visual indication the apparatus is provided with an optical source within the cutting head. Light from this optical source is propagated through a plastic optical fiber filament to its tip. Light from the light source is visible at the tip of the filament and the lighted tip is visible to the operator of the cutting tool. A light trail or arc of light is created as the plastic optic fiber filament spins. This light trail is used as a guide to indicate the cutting path of the tool. As only the tip and any roughened edges of the filament are lit, the operator can readily see which part of the tool is at its outermost extreme. As the tip of the filament becomes worn due to its cutting action, the lighted section remains at the outermost end of any newly-created cutting tip.

This system for lighting the tip of the flail is appropriate for utilization in devices using a variety of “bump and feed” mechanisms. These mechanisms allow new filament to be extended from the cutting head whilst the cutting head is in motion. The light source is powered by an integrated electrical generation system which transforms the rotational power of the device into electrical current. The power required for the light source is derived from rotational energy provided by the drive shaft and there is no need for an additional power source to operate the light. The generation of electrical power occurs only when the tool is rotating and thus there is no need for a separate switching mechanism to operate the light source.

A practical example of the flexibility possessed by the present invention is its utilization in a wide variety of rotary mowers, trimmers, edgers of vegetation and other cutting devices. The primary rotational power for these devices comes mainly from electrical or internal combustion motors. Because all of the components needed to operate the present invention are contained within the cutting head, the present invention can be used without major adaptation in electrical or internal combustion powered trimmers edgers of vegetation and rotary cutting tools.

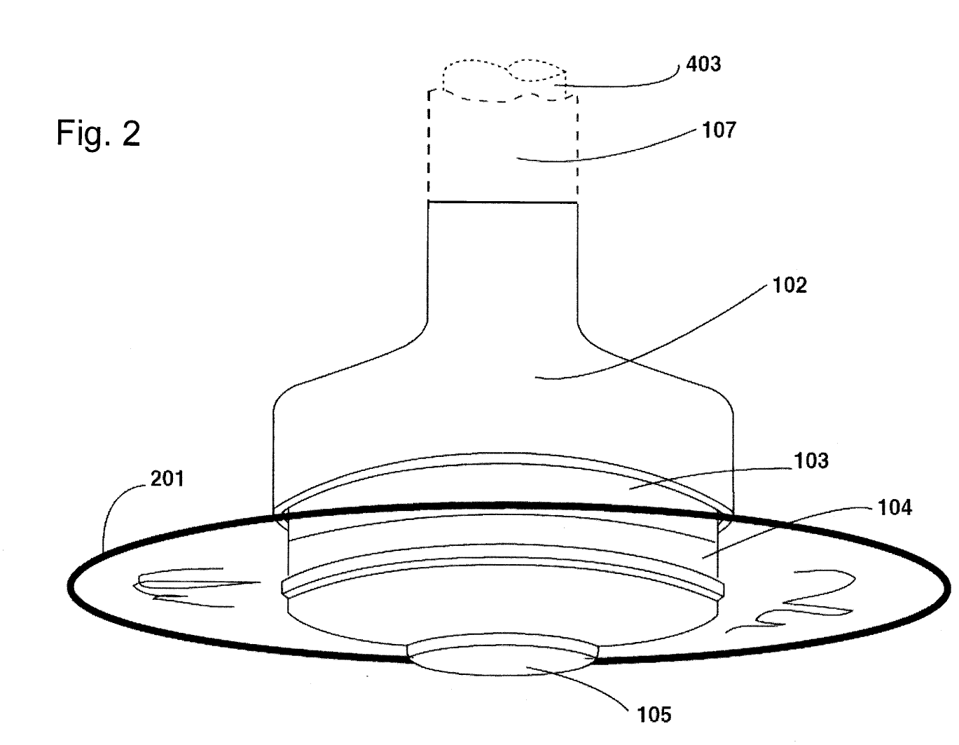

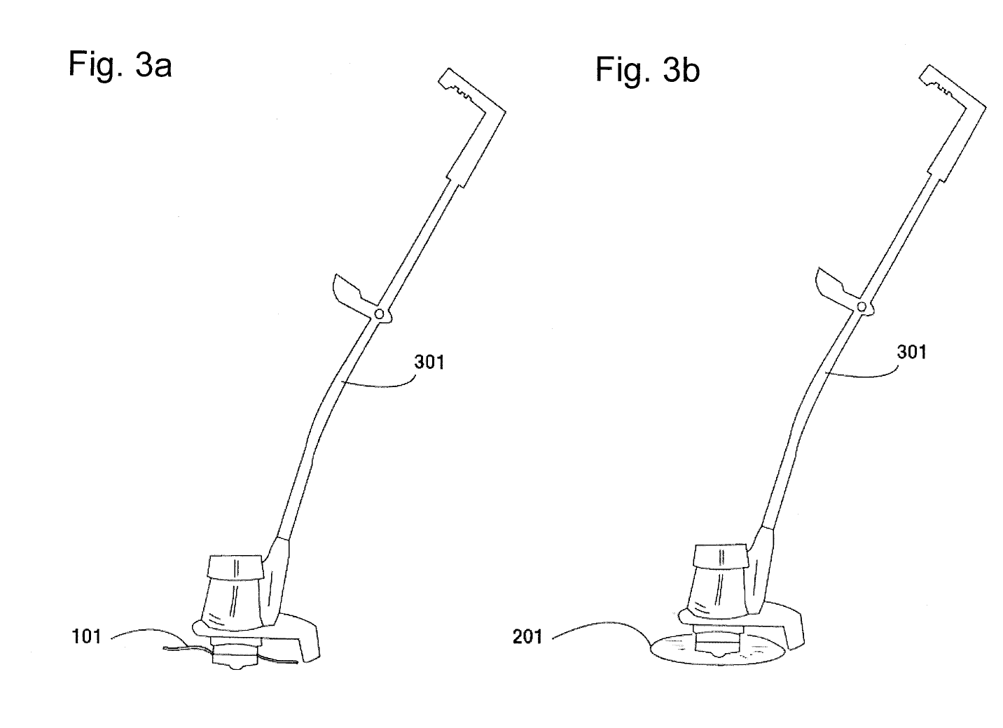

With reference to the drawings wherein like references indicate like or similar elements throughout the several views and, in particular reference to FIG. 1-4 there is shown the cutting head and plastic optical fiber filament 101. The plastic optical fiber filament 101 extends outward from the cutting head. As the cutting head rotates the filament 101 is drawn outward by centrifugal force, and once directed by the operator can be utilized to cut vegetation or other material in a flailing action. As shown in FIG. 2 and FIG. 3B when the rotary mower, trimmer, edger of vegetation or rotary cutting device 301 is in operation the plastic optical fiber filament 101 creates a cutting circle 201. The cutting head is placed at the distal end of the upper drive shaft 404 of a rotary mower, trimmer, edger of vegetation or rotary cutting device 301. The cutting head is comprised of three parts, the outer housing 102, the upper housing 103 and the lower housing 104.

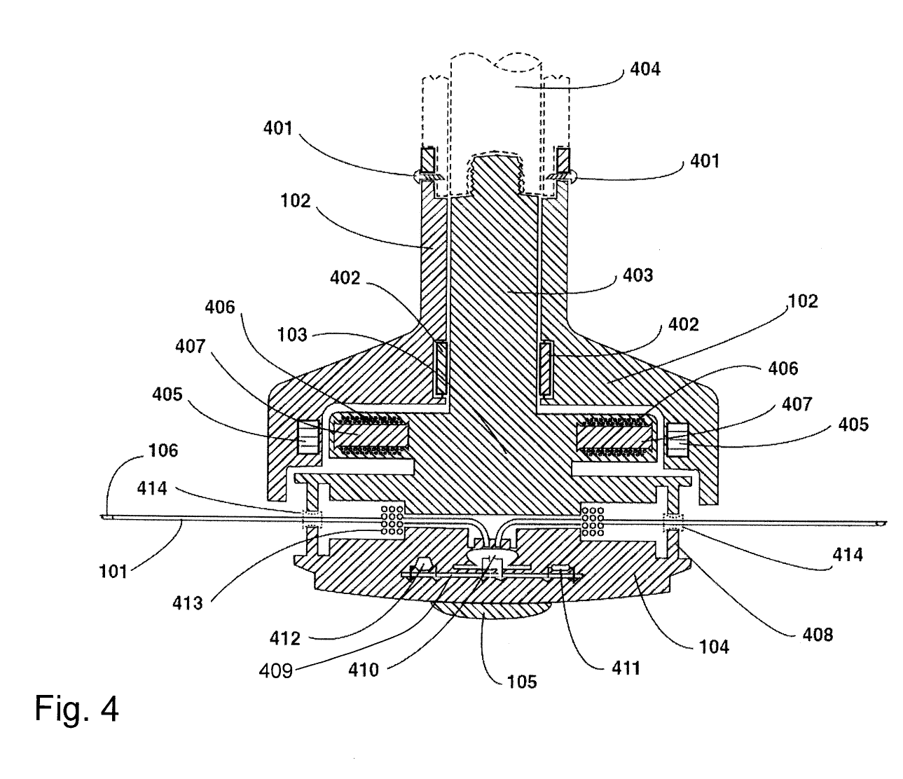

In particular reference to FIG. 3A and FIG. 3B the rotary mower, trimmer, edger of vegetation or rotary cutting device 301 will only be described herein to the extent that it is relevant to the operation of the invention, however it should be noted that this invention would be suitable for various types of electrical and internal combustion powered rotary cutting devices which use rotating filament flails for cutting. In reference to FIG. 4 the outer housing 102 is attached by screws 401 or otherwise fixed to the outer cover 107 of a rotary mower, trimmer, edger of vegetation or rotary cutting device 301. Roller bearings 402 are placed between the outer housing 102 and the upper housing 103 to allow for the smooth rotation of the drive shaft 403. When the drive shaft 403 of the cutting device 301 rotates the outer housing 102 remains stationary. The outer housing 102 is manufactured as an integral molding of a suitable non-magnetic polymeric material.

One or more permanent magnets 405 are embedded into the outer housing 102 during the manufacturing process. When the drive shaft 403 is rotating, the permanent magnets 405 induce a flow of electrical current in copper coils 406 located in the upper housing 103. These copper coils 406 being wound around iron cores 407. The upper housing 103 is screwed onto the drive shaft 403 of a rotary mower, trimmer, edger of vegetation or rotary cutting device. The upper housing 103 is manufactured as an integral molding of a suitable non-magnetic polymeric material. The copper coils 406 and their associated iron cores 407 and connectors are encased in the housing during the manufacturing process.

When the cutting head rotates, current induced in the copper coils 406 is transferred to copper connectors via wiring in the upper housing 103. The copper connectors are placed at the distal end of the upper housing 103 and connect with similar copper connectors on the top of the lower housing 104. Electrical current is passed from the upper housing 103 to the lower housing 104 via the union of these connectors. The lower housing 104 of the cutting head is attached to the upper housing 103 via a bayonet-type fitting 408. This fitting is designed to ensure that the upper and lower connecting strips are in contact with one another when the housings are attached to one another. The lower housing 104 is manufactured as an integral molding of a suitable polymeric material or from a light weight metal such as aluminum.

The lower housing 104 of the cutting head contains an electronic circuit board 409 onto which rectification circuitry 411, voltage regulation circuitry 412 and a light source 410 are mounted. Electrical current from the top connector of the lower housing 104 is sent to the circuitry through wiring in the lower housing 104. The electronic circuitry contains rectification circuitry 411 to convert the alternating or oscillating current from the copper coils 406 into unidirectional or direct current. The electronic circuitry also contains voltage regulation circuitry 412 to stabilize the voltage at a level appropriate to the light source 410.

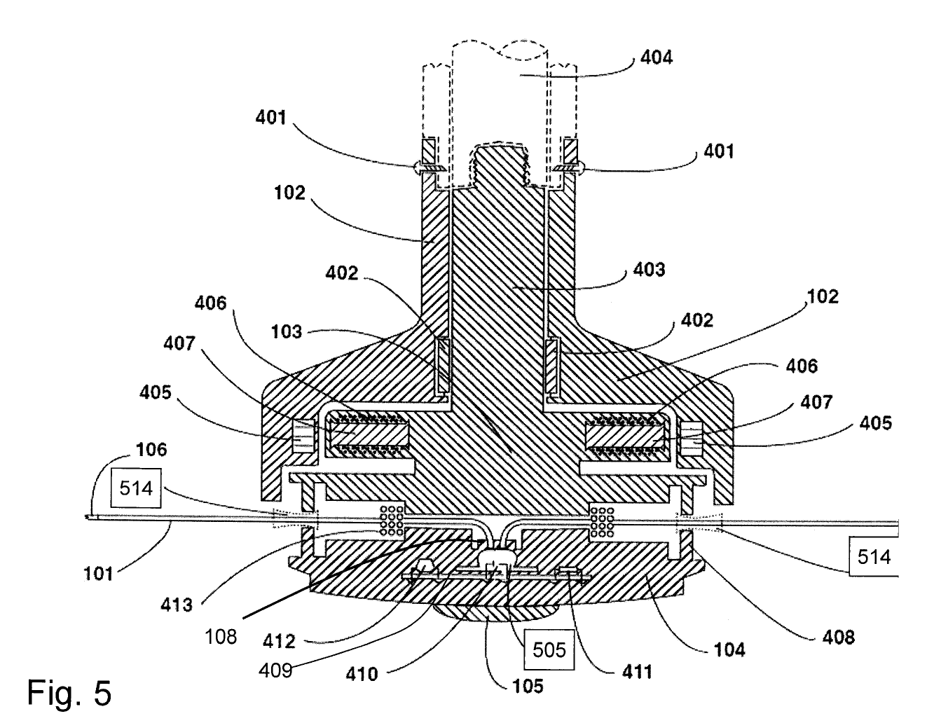

The plastic optical fiber filament 101 is held within a spool 413 wound around the core formed by upper housing 103 and lower housing 104. Inner end 108 of the plastic optical fiber filament 101 being coupled to the light source 410 and receiving the light which is then “guided” by the plastic optical fiber filament 101 to the tip 106. Optionally, the plastic optical fiber filament 101 as it exits through the bayonet-type fitting 408 is reinforced with a sleeve 414 that is held within the bayonet-type fitting 408 as shown in FIG. 4 or an extended sleeve 514 as shown in FIG. 5.

Preferably, the light sources 410 utilized are commercially available incandescent bulbs or light emitting diodes, examples of which are capable of generating in excess of 100 lumens of light. A light source lower than 100 lumens may also be used but may provide reduced visibility of the tips 106 of the plastic fiber optical filaments 101 in very bright sunlight. Light emitting diodes beneficially offer robustness, efficient light generating capabilities and low operating temperatures.

Referring to FIG. 5 shown is a second embodiment of the invention having a similar design to that presented supra in respect of FIGS. 1 through 4 with the exception that an optical lens 505 is inserted between the inner end 108 of the plastic optical fiber filament 101 and the optical source 410. The optical lens 505 provides for an increased efficiency or alternatively increased brightness of the tips 106.

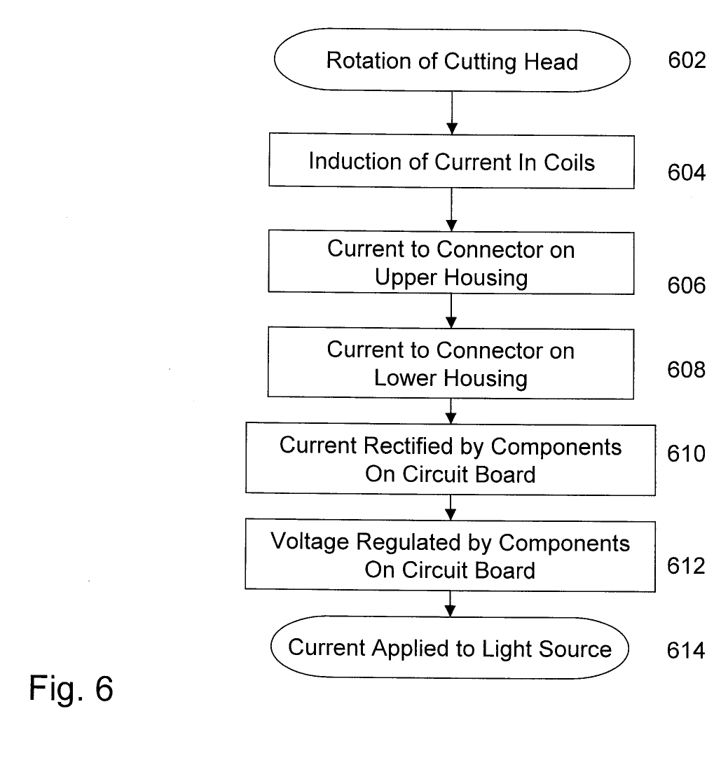

Now referring to FIG. 6 shown is an exemplary flow for self-generation of the power required for the optical source 410 within the rotary mower, trimmer, edger of vegetation or rotary cutting device 301. At step 602 rotation of the cutting head occurs, driven by an electric motor or an internal combustion engine, thereby generating in step 604 an induction current within the copper coils 406. This current is then coupled to the conductors within the upper housing 103 in step 606, and therefrom to the lower housing 104 in step 608.

The induced current is then rectified using rectification circuitry 411 on the electronic circuit board 409 in step 610. This rectified signal is then voltage regulated in step 612 using the voltage regulation circuitry 412 on the electronic circuit board 409. This regulated signal is then coupled to the light source 410, thereby powering and illuminating the tip 106 of the plastic fiber optical filaments 101.

Whilst the embodiments of the invention described supra in respect of FIG. 1 to FIG. 6 are presented with respect to a plastic filament, alternatively other materials providing suitable propagation of the optical source to the distal end within the visible portion of the electromagnetic spectrum and appropriate mechanical properties can be employed. Such materials including glass fibers, fibers incorporating nano-structures, or nano-structure composites.

Numerous other embodiments may be envisaged without departing from the spirit or scope of the invention.

1. A method comprising: providing a rotating head comprising at least an optical source, the rotating head forming a predetermined portion of a rotary cutting device; providing a coupling, the coupling providing at least a demountable interface for a filament to provide an optical coupling between the optical source and the filament; providing electrical power to operate the optical source and thereby providing an illumination visible to an operator of an exposed distal end of the filament during operation of the rotary cutting device.

2. A method according to claim 1 wherein, providing electrical power comprises providing electrical power generated within the rotating head from the rotary motion of the rotating head relative to an aspect of the body of the rotary cutting device.

3. A method according to claim 1 wherein, providing electrical power comprises providing an electrical generator within the rotary cutting device, a first predetermined portion of the electrical generator within the rotating head and a second predetermined portion of the electrical generator within a body of the rotary cutting device.

4. A method according to claim 1 wherein, providing a coupling comprises providing at least one of a retaining mechanism for the filament, an optical lens, an optical focusing arrangement, a mounting for the optical source.

5. A method according to claim 1 wherein, providing the optical source comprises providing at least one of a compound semiconductor emitter, an incandescent source, and a fluorescent source.

6. A method according to claim 1 wherein, the optical source provides a luminous flux of at least 1 lumens at a distal end of the filament from the optical source.

7. A method according to claim 1 wherein, providing the rotating head further comprises providing at least one of storage for a predetermined length of the filament, and a release mechanism for the filament allowing the distal end of the filament to be further extended during operation of the rotating cutting device by an action of the operator.

8. A method according to claim 1 wherein, providing the filament comprises providing a dielectric waveguide propagating light coupled from the optical source to a distal end of the filament by total internal reflection.

9. A method according to claim 1 wherein, providing the coupling further comprises a hold-and-release element allowing a predetermined stored portion of the filament to be fed out whilst maintaining the coupling between the optical source and the filament.

10. A rotary cutting device comprising: a body comprising at least a handle and a motor; and a rotating head attached to the motor and able to freely rotate with respect to the body, the rotating head comprising at least a demountable mount for a filament, and an optical source optically coupled to the filament and providing an illumination of the filament when electrically powered.

11. A rotary cutting device according to claim 10 wherein, providing the body further comprises providing a first predetermined portion of an electrical generator; providing the rotating head further comprises providing a second predetermined portion of the electrical generator; and wherein rotation of the rotating head relative to the body provided by operating the motor results in electrical power being provided to the optical source.

12. A rotary cutting device according to claim 10 wherein, providing electrical power to the optical source comprises providing at least one of a battery and a power supply generated from an electrical mains signal coupled to the cutting device.

13. A rotary cutting device according to claim 10 wherein, in operation the optical source provides for an illumination of a distal end of the filament by total internal reflection.

14. A rotary cutting device according to claim 10 wherein, providing the optical source comprises providing at least one of an optical lens, an optical focusing arrangement, a mounting for the optical source, a compound semiconductor emitter, an incandescent source, and a fluorescent source.

15. A rotary cutting device according to claim 10 wherein, the optical source provides a luminous flux of at least 1 lumens at a distal end of the filament.

16. A rotary cutting device according to claim 10 further comprising: a hold-and-release element to allow a predetermined stored portion of the filament to be fed out whilst maintaining the coupling between the optical source and the filament.

17. A rotary cutting device according to claim 10 wherein, the rotating head further comprises at least one of storage for a predetermined length of the filament, and a receptacle for accepting therein a removable cartridge of filament, the receptacle providing an aspect of alignment of the filament and the optical source.

18. A rotary cutting device according to claim 10 wherein, the rotating head further comprises a guide formed from at least one of a semi-rigid material and a rigid material, the guide for surrounding at least a predetermined portion of the filament allowing freedom of motion of the filament through the guide.

19. A method of controlling a cutting action comprising: providing a rotary cutting device comprising at least an upper body comprising at least a motor and a lower body comprising at least an optical source coupled to an electrical circuit, the electrical circuit connected to a source of electrical power; providing a filament demountably attached to the lower body having a first end optically coupled to the optical assembly and a second distal end; wherein operating the rotary cutting device results in electrical power being provided to the electrical circuit to operate the optical source and thereby provide a visual indication to an operator of the location of the second distal end of the filament.

20. A method according to claim 19 wherein, providing a source of electrical power comprises providing at least one of an electrical generator, a battery, and an extension cord for connecting to an electrical power socket.

21. A method according to claim 19 wherein providing an electrical generator comprises providing a first predetermined portion of the electrical generator within the upper body and a second predetermined portion of the electrical generator within the lower body.

22. A method according to claim 19 wherein, providing an indication of the location of the second distal end of the filament improves an aspect of accuracy of the cutting action of the rotary cutting device.

23. A method of controlling a cutting action comprising; providing a rotary cutting device comprising at least a means of providing electrical power to operate an optical source forming a predetermined portion of the rotary cutting device, the optical source therein illuminating a first end of a filament and providing a visual indication of the location of a second distal end of the filament to an operator of the rotary cutting device, the visual indication improving a measure of control of the rotary cutting device.

24. A method according to claim 23 wherein, providing the electrical power to operate the optical source comprises providing an electrical generator as part of the rotary cutting device to generate the electrical power during operation of the rotary cutting device.

25. A method according to claim 23 wherein, providing the visual indication comprises providing a luminous flux at the second distal end of the filament of at least 1 lumens.

26. A method according to claim 23 wherein, providing the filament comprises providing a dielectric waveguide propagating an optical signal by means of total internal reflection.
